(19) United States
(12) Patent Application Publication
(10) Pub. No.: US 2011/0093406 A1
(43) Pub. Date: Apr. 21, 2011

(54) USER INTERFACE WORKFLOW COMPOSITION METHOD, SYSTEM AND COMPUTER PROGRAM PRODUCT

(75) Inventors: Mark Angel, Menlo Park, CA (US); Rob Arsenault, Menlo Park, CA (US); Max Copperman, Menlo Park, CA (US); Charlie Isaacs, Menlo Park, CA (US); Samir Mahendra, Menlo Park, CA (US); Vikas Nehru, Menlo Park, CA (US); Dilpreet Singh, Menlo Park, CA (US)

(73) Assignee: KANA SOFTWARE, INC., Menlo Park, CA (US)

(21) Appl. No.: 12/603,524

(22) Filed: Oct. 21, 2009

(51) Int. Cl. G06Q 10/00; G06F 3/048; G06F 17/30

(52) U.S. Cl. 705/348; 715/771; 707/802; 707/E17.044

(57) ABSTRACT

Embodiments of the present invention provide a method, system and computer program product for user interface workflow composition. In an embodiment of the invention, a user interface workflow composition method can include loading a set of references to both human steps of a workflow and also automated steps of a workflow. Each of the human steps of the workflow references a corresponding user interface. Further, each of the human steps and automated steps of the workflow individually include contextual data. Individual graphical elements each representative of a selected one of the human steps and automated steps is placed into a canvas and transitions can be defined between different ones of the human steps and automated steps represented by corresponding ones of the graphical elements in the canvas resulting in the specification of a user interface workflow. Consequently, computer readable instructions can be generated for the user interface workflow.

### BACKGROUND OF THE INVENTION

1. Field of the Invention

The present invention relates to the field of business process modeling (BPM) and more particularly to workflow composition for business process modeling.

2. Description of the Related Art

Process modeling relates to the modeling of dynamic or static systems, which can include, but are not limited to, enterprise management systems, customer relationship management (CRM) systems, engineering systems, networked information technology systems, utility systems, utility computing systems, autonomic computing systems, on-demand systems, electric power grids, biological systems, medical systems, weather systems, financial market systems, and business process systems. Such systems can be modeled and simulated for a variety of purposes including monitoring, analysis, control, design, simulation, and management.

A process model is an abstract description of a process such as a business process or any other process related to the lifecycle of a system. The abstract description of the process model can include sufficient detail required by a simulation engine for exercising the process model with one or more scenarios to determine a likely outcome. Process models generally specify one or more steps or activities of a process and the relationship between the different steps or activities. As part of the model, one or more events or conditions leading to the transition from one step or activity to the next can be specified so as to define a workflow. Models defining a workflow generally are expressed according to a specific format. Exemplary formats include Activity Decision Flow (ADF) Unified Modeling Language (UML) activity diagrams, and the Business Process Execution Language (BPEL), to name only a few.

Workflows created in a BPM environment can be deployed for execution and execution lifecycle management in a Web services architecture. As it is well-known in the art, generally, a workflow process execution engine accepts as input a workflow such as that specified in BPEL, and produces one or more executable instances of components requisite to the workflow. Thereafter, the executable instances can be deployed in a network accessible architecture such that end users can access the workflow remotely from over a computer communications network.

Workflows have proven particularly effective in CRM applications. Generally, a workflow for a CRM application can specify a series of steps or activities to be performed either automatically (computer steps) or by a person (human steps) and can include by way of example, a step for retrieving a customer record, a step scripting a dialog with a customer, or a step for sending a responsive message to a customer inquiry. Transitions between steps can be governed by rules and workflows can be triggered by events. Notwithstanding, defining the workflows including triggering events, steps and transitions can be tedious for the uninitiated. Consequently, several workflow design tools provide for the graphical expression of workflows in order to ease the process of designing workflows.

By way of example, conventional workflow design tools for CRM provide a graphical user interface through which a business analyst can specify a flow steps to be performed by an end user in providing CRM services. Sophisticated workflow design tools provide a further capability of a drag and drop interface for defining a workflow by dragging and dropping steps from a listing of available steps onto a palette. The drag and drop nature of the conventional workflow design tool acts to minimize the necessity of software development expertise in composing a workflow for CRM. Even still, conventional workflow design tools for CRM lack a close coupling to the nature of CRM workflow and leave much omitted requiring technical intervention by a software developer. Examples include generating different screens for different steps in a workflow, determining the exchange of contextual data between steps in a workflow and determining and policing service level objectives for different steps in a workflow. Indeed, the user interface of the conventional workflow design tool leaves much to be desired in terms of convenience and simplicity.

### BRIEF SUMMARY OF THE INVENTION

Embodiments of the present invention address deficiencies of the art in respect to workflow design tools and provide a novel and non-obvious method, system and computer program product for user interface workflow composition. In an embodiment of the invention, a user interface workflow composition method can include loading into a composition module executing in memory by a processor of a computer from a data store coupled to the computer, a set of references to both human steps of a workflow and also automated steps of a workflow. Each of the human steps of the workflow references a corresponding user interface. Further, each of the human steps and automated steps of the workflow individually include contextual data. The method also can include visually placing individual graphical elements each representative of a selected one of the human steps and automated steps into a canvas rendered by the composition module.

Transitions can be defined between different ones of the human steps and automated steps represented by corresponding ones of the graphical elements in the canvas by creating visual connections between the different ones of the graphical elements in the canvas. In particular, the human steps and automated steps each are represented by the graphical elements in the canvas so that the transitions defined therebetween set forth a user interface workflow. Consequently, computer readable instructions can be generated for the user interface workflow. Thereafter, the computer readable instructions can be provided to a workflow engine to generate programmatic objects implementing the user interface workflow and to execute the programmatic objects for use by end users over a computer communications network.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for user interface workflow composition;

FIG. 2 is a schematic illustration of a workflow composition data processing system configured for user interface workflow composition;

FIG. 3A is a screen short of a user interface workflow designer in the workflow composition data processing system of FIG. 2 in which different steps and collections of steps can be selected in a palette of the user interface and placed onto a canvas of the user interface;

FIG. 3B is a screen shot of a runtime display for a collection of steps aggregated in the user interface workflow of FIG. 3A;

FIGS. 4A through 4D, taken together, are a screen shot of a user interface workflow designer in the workflow composition data processing system of FIG. 2; and,

FIG. 5 is a flow chart illustrating a process for data mapping data in a context for a target step in a user interface workflow to data in a context for a source step in the user interface workflow in the workflow composition data processing system of FIG. 2; and,

FIG. 6 is a flow chart illustrating a process for user interface workflow composition.

### DETAILED DESCRIPTION OF THE INVENTION

Embodiments of the present invention provide a method, system and computer program product for the visual composition of a flow of end user interactions with different steps of a workflow, hereinafter referred to as a user interface workflow. In accordance with an embodiment of the present invention, an user interface workflow composition tool can be provided to facilitate the composition and deployment of a workflow into a computer communications network. The composition tool can provide a unified graphical user interface including a palette in which a listing of references to available steps for inclusion in a user interface workflow can be rendered. Importantly, the steps can include both human steps and automated steps, for example those that pertain to CRM though the invention is in no way limited to the field of CRM.

The unified graphical user interface also can include a portion in which a canvas can be rendered. The canvas can accept the placement of graphical elements corresponding to selected ones of the references to the available steps. The different graphical elements in the canvas can be visually linked to others of the graphical elements so as to represent an ordering of flow from one step to another, the collection of graphical elements in the palette defining a user interface workflow representative of a sequence of user interface screens experienced by an end user when interacting with the workflow. In this regard, the execution of a step in the user interface workflow can result from a transition from one or more other steps and one or more steps can be executed subsequent to the completion of a step. Optionally, any of the graphical elements disposed in the palette can be linked to another, different user interface workflow.

Of note, a mapping of contextual data for each step can be defined in yet another portion of the unified graphical user interface responsive to the selection of a corresponding graphical element in the palette. The mapping of the contextual data can be defined according to the type of data utilized within the step or produced by the step. The mapping of the contextual data further can be defined according to the source of the contextual data to the extent that the contextual data is to be provided to the step. Alternatively, the contextual data further can be defined according to a target recipient of the contextual data to the extent that the contextual data is produced by the step. In either case, the contextual data yet further can be defined according to a mapping type of the contextual data indicating whether the data is to be provided to a target recipient step, to be received from a source recipient step, or both or whether the data enjoys a manually specified value.

Finally, a user interface screen for each step in the canvas can be defined. While a screen can be pre-specified for each step, each screen can be modified through the unified graphical user interface. In this regard, display controls of each screen can be repositioned in the screen and additional display controls can be added to the screen. An association further can be stored in connection between each screen and a corresponding step.

The user interface workflow defined within the canvas of the composition tool can be persisted as artifacts in a database, and subsequently converted into an archive or archives of computer readable instructions suitable for use by a workflow engine. In one aspect of the invention, the user interface workflow can be compiled to BPEL for use as a source document in a workflow engine converting the source document into a series of executable components accessible to end users from over a computer communications network. For example, the components can be placed in container defined within an application server and accessible by way of a services oriented architecture (SOA) provided in a Web services framework.

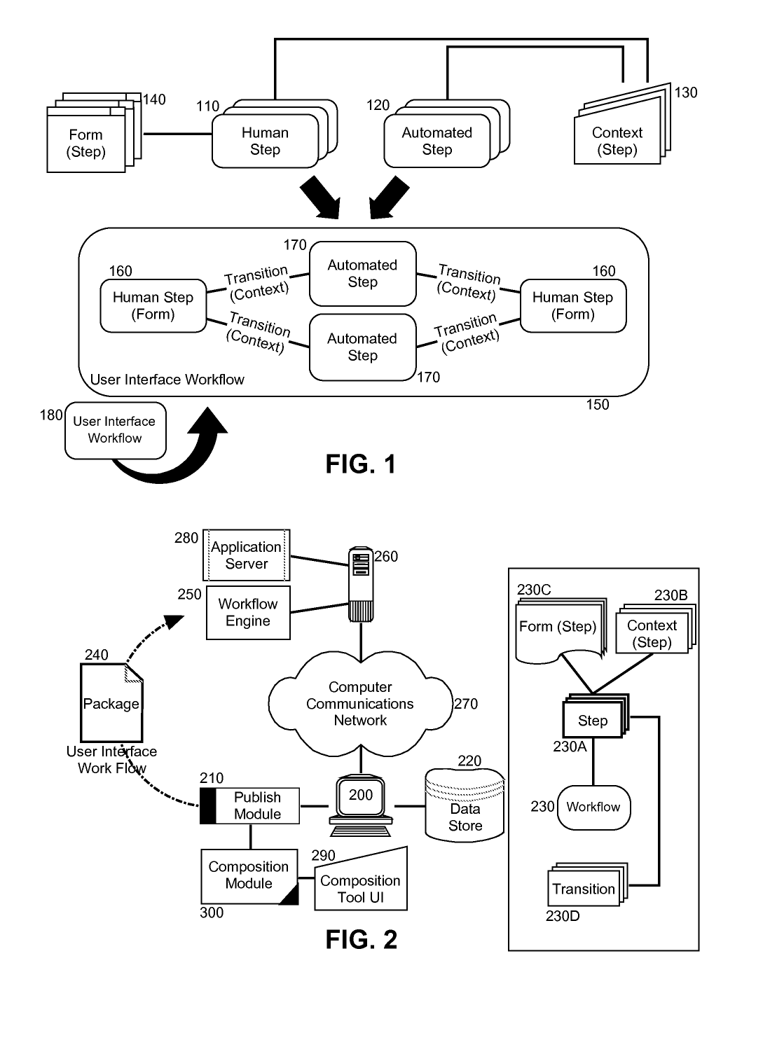

In further illustration, FIG. 1 is a pictorial illustration of a process for user interface workflow composition. As shown in FIG. 1, different steps 110, 120 can be defined for selection and use in a user interface workflow 150. The steps 110, 120 can include both human steps 110, and automated steps 120. Human steps 110 are steps to be performed by a user such as conducting a conversation with a customer, or building a message to be transmitted to a customer. A human step 110 completes when the user indicates that the step is complete through a suitable user interface control disposed in a screen for the human step 110. By comparison, an automated step 120 is a step to be performed programmatically by a computer, such as the retrieval of data and placement of the data in different fields of a form rendered in connection with the automated step 120. Importantly, a user interface 140—typically a screen or form—for each human step can be specified in connection therewith. As such, referencing a human step 110 necessarily references a corresponding user interface 140 for the human step 110. Also, both the human steps 110 and the automated steps 120 can be associated with corresponding context 130—specifically data used or produced by an associated step.

Different ones of the steps 110, 120 can be selected for inclusion in the user interface workflow 150. By way of example, as illustrated, human steps 160 and automated steps 170 can be placed in the user interface workflow 150. Further, one or more screens 140 previously associated with a corresponding one of the steps 160, 170 can be recognized as part of the user interface workflow 150 and a context 130 for each of the steps 160, 170 can be specified including a mapping of a source and/or target for data present in the steps 160, 170. Of note, data mapping can be specified manually by the end user, or data mappings can be determined algorithmically by seeking common data types between steps 110, 120 in the user interface workflow 150. Finally, one or more transitions can be defined for each of the human steps 160 and automated steps 170 indicating upon which condition or conditions a currently focused one of the steps 160, 170 is to end and a next one of the steps 160, 170 is to begin in the user interface workflow 150, and also which next one of the steps 160, 170 is to be invoked upon the ending of a contemporary one of the steps 160, 170.

Of note, the user interface workflow 150 is re-usable once defined such that other user interface workflows 180 can reference the user interface workflow 150 in the same way steps 110, 120 are referenced in the other user interface workflows 180. In this way, robust and unique user interface workflows can be defined over time using existing user interface workflows known to be effective thus obviating the need to invest substantial time and technical resources in developing new user interface workflows. Further, minor modifications requisite to adapting an existing user interface workflow to a new environment need not provoke the completely new specification of a new user interface workflow.

The process described in connection with FIG. 1 can be implemented within a workflow composition data processing system. In further illustration, FIG. 2 is a schematic illustration of a workflow composition data processing system configured for user interface workflow composition. The system can include a computer system 200 with processor and memory configured for communicative coupling to a remote server 260 over computer communications network 270. An operating system can execute in the memory of the computer system 200 to support the operation of a composition module 220 providing composition tool user interface 290.

In this regard, the composition module 220 can include computer program instructions that when loaded into the memory of the computer system 200 and executed by the processor of the computer system 200 can be enabled to load from data store 230 a set of references to different steps 230A for display in a palette of the composition tool user interface 290. The computer program instructions further can be enabled to permit the selection and placement of different ones of the steps 230A onto a canvas of the composition tool user interface 290 each in the form of a graphical representation of a corresponding one of the steps 230A. Yet further, the computer program instructions can be enabled to permit the configuration of a context 230B of contextual data for each of the steps 230A represented by a corresponding graphical element in the canvas, including a type, source and mapping for the contextual data in the context 230B.

Even yet further, the computer program instructions can be enabled to identify different pre-associated screens 230C with different ones of the steps 230A represented by a corresponding graphical element in the palette, and also to permit editing of a layout of the different screens 230C. Finally, the computer program instructions can be enabled to permit the establishment of one or more transitions 230D between one or more of the steps 230A represented by a corresponding graphical element in the canvas so as to specify under what condition or conditions a contemporary one of the steps 230A has completed and a next one of the steps 230A is to begin.

The aggregation of the steps 230A represented by corresponding graphical elements in the palette of the composition user interface 290, along with the specified contexts 230B, screens 230C and transitions 230D, can be persisted as a user interface workflow 230—literally, artifacts in the data store 220. Publisher module 210 can compile and publish the artifacts of the workflow 230 into computer readable instructions 240 such as an enterprise archive (EAR) for deployment by a workflow engine 250 executing by an application server 280 in memory by a processor of the remote server 260 for use by different end users over the computer communications network 270.

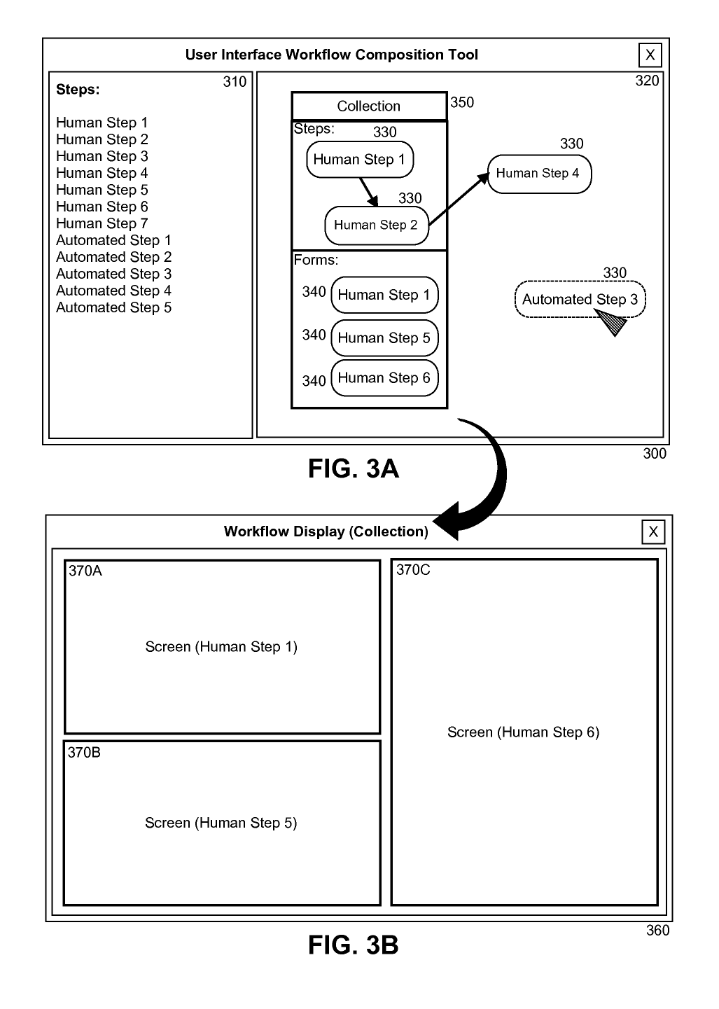

It is to be recognized, then, that integral to the composition of the user interface workflow 240 is the convenience of composition provided by the composition tool user interface 290. As such, in yet further illustration of the composition tool user interface, FIG. 3A is a screen short of a user interface workflow designer in the workflow composition data processing system of FIG. 2 in which different steps and collections of steps can be selected in a palette of the user interface and placed onto a canvas of the user interface. As shown in FIG. 3A, a user interface workflow composition tool 300 can provide both a palette 310 of available human and automated steps, and also a canvas 320 into which graphical elements 330 representative of selected ones of the steps in the palette 310 can be placed and related to one another through specified transitions so as to define a workflow.

As will be apparent from FIG. 3A, steps can be placed into the canvas individually, or steps can be grouped together as a collection 350—generally, a sequence of steps 330 to be performed in one sitting by a single person. For each collection, corresponding user interface screens or forms can be identified for presentation in conjunction with each corresponding associated step 330 in the collection 350. Further, additional user interfaces 340 can be placed into the collection 350 for presentation concurrently with the user interfaces for the specified steps 330 aggregated in the collection 350. Importantly, FIG. 3B is a screen shot of a runtime display 360 for the collection 350 of steps 330 aggregated in the user interface workflow of FIG. 3A demonstrating the automated arrangement of user interfaces 370A, 370B, 370C corresponding to those user interfaces 340 specified in the collection 350.

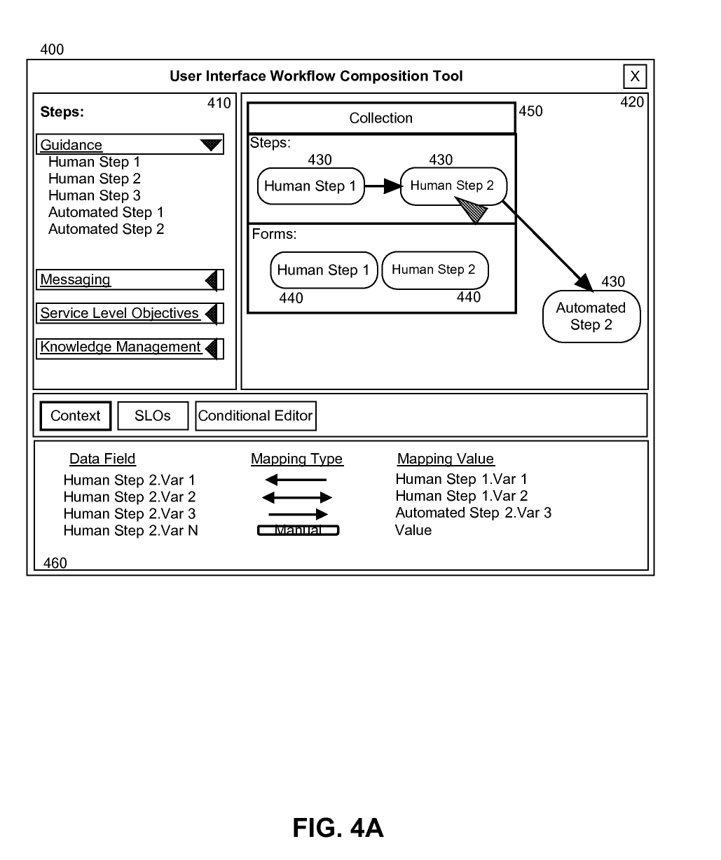

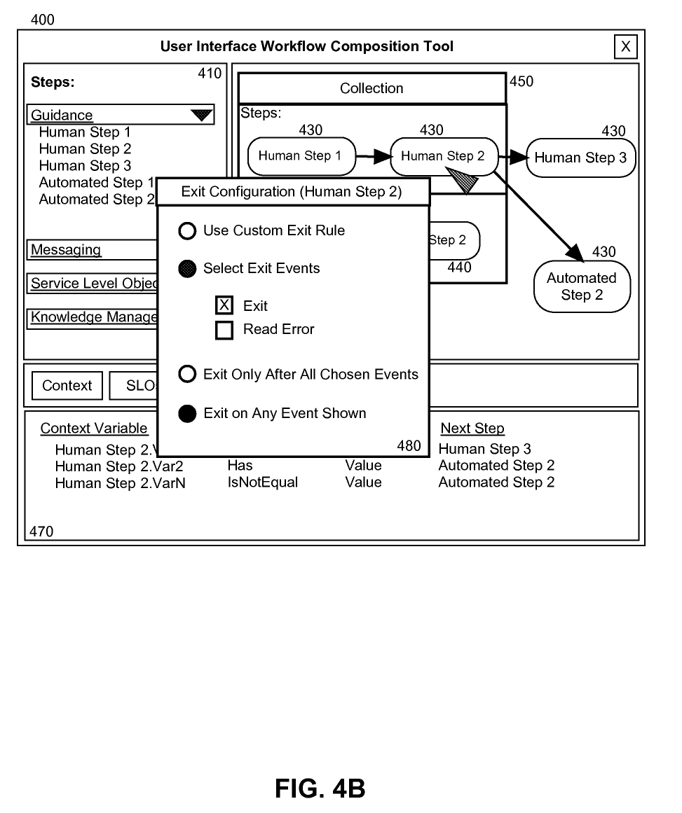

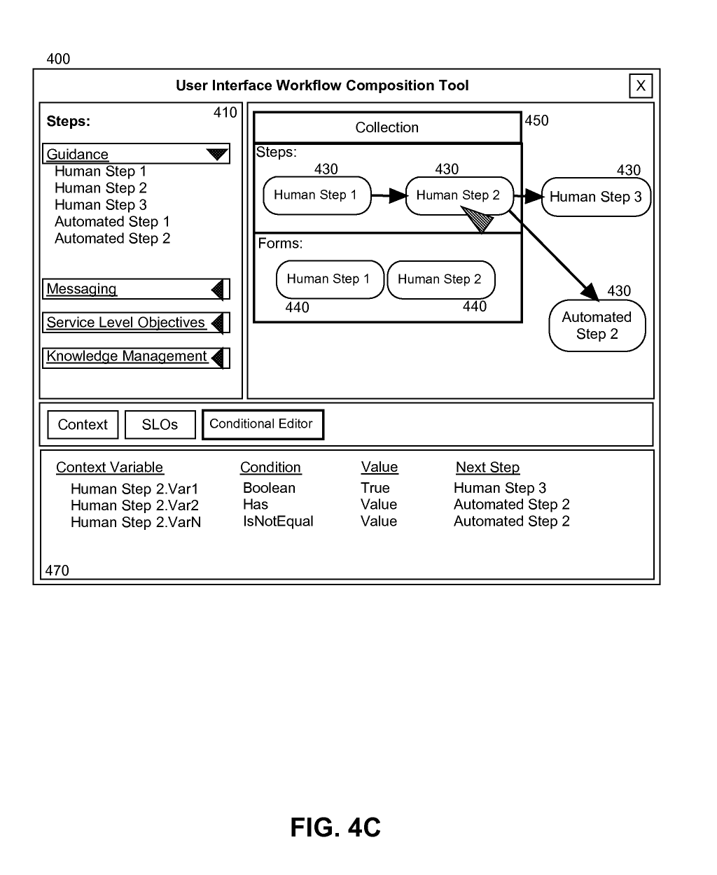

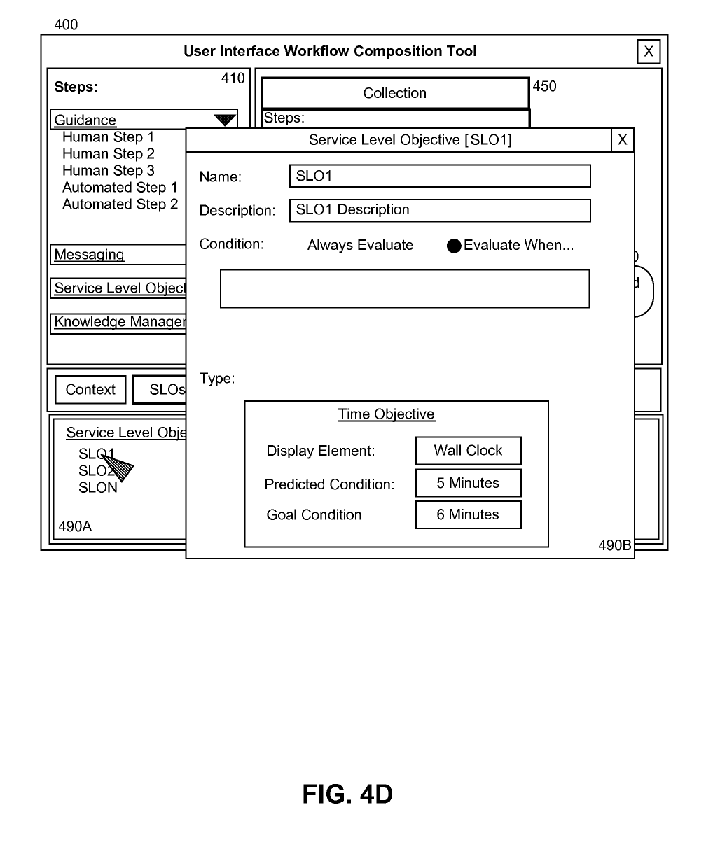

In yet further illustration, FIGS. 4A through 4D, taken together, are a sequence of screen shots of a user interface workflow designer in the workflow composition data processing system of FIG. 2. As shown in FIG. 4A, a user interface to the composition tool 400 can include a palette 410, a canvas 420, and a context portion 460. The steps portion 310 can include a listing of step references. Each entry in the listing of steps can be selected for placement in the canvas 420, for example by way of drag-and-drop functionality. Once placed in the canvas 420, a reference from the listing can be visually represented by a graphical element 430. In this regard, the graphical element 430 can correspond to an underlying step—either a human step or an automated step. Further, the graphical element 430 can be placed alone in the canvas 420, or within a collection 450 of other graphical elements 430 along with corresponding user interface screens or forms 440 to be displayed concurrently in a single display for the collection 450 irrespective of a which step contemporaneously executes for the collection 450. Of note, the different graphical elements 430 can be graphically linked within the canvas 420 so as to define transitions between the underlying steps.

Importantly, the context portion 460 can provide a user interface through which different contextual data utilized in a step corresponding to a selected graphical element 430 in the palette 420 can be configured in terms of the contextual data, a source or target of the contextual data and a mapping indicating whether the contextual data is to be provided to a target, to be received from a source, or both, or manually specified to have a particular value. To facilitate the establishment of the contextual data, the potential source or target of specified contextual data can be listed in the context portion 450 for selection by the end user in connection with particular contextual data.

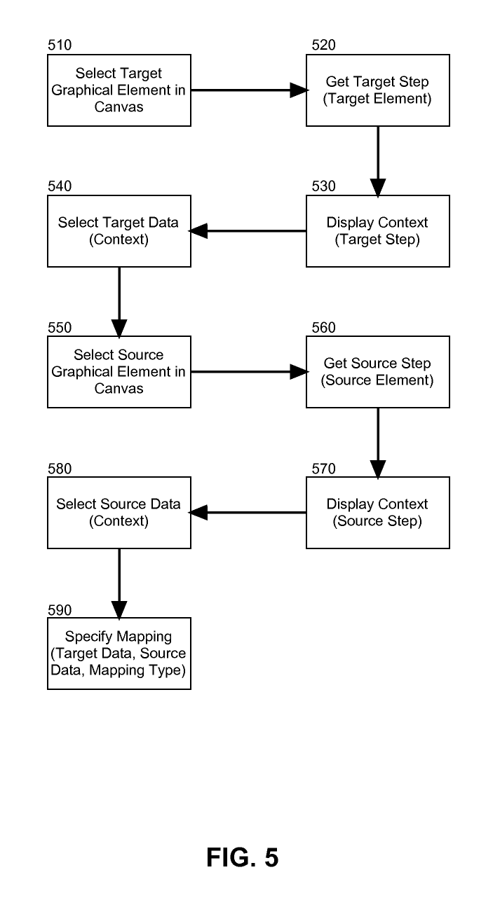

Optionally, as illustrated by the flow chart of FIG. 5, the mapping of data from source to target can be facilitated through the automated retrieval of target data and source data for the target data. In this regard, referring to FIG. 5, in block 510, a target step can be selected in the canvas graphically, for instance through the use of a pointing device or keyboard. A target step underlying the selected graphical element can be identified in block 520 and in block 530 the contextual data for the target step can be displayed. Thereafter, in block 540, target data to be mapped can be selected in the display of contextual data.

Subsequently, in block 550 a graphical element in the canvas can be selected by way of mouse pointing device or keyboard, for example, as the source of the data for the selected target data. Specifically, in block 560, a source step underlying the selected graphical element can be identified an in block 570, the contextual data for the source step can be displayed. Thereafter, in block 580 specific data can be selected in the display as the source of the target data and in block 590 a mapping therebetween can be stored.

For each human step corresponding to a graphical element placed in the canvas, both criteria for determining when the human step has exited and also criteria for selecting a step to which to transition can be set forth in the composition tool. Referring to FIG. 4B, an exit condition for a selected graphical element 430 corresponding to a human step in the canvas 420 can be set forth by way of separate dialog box 480 as shown in FIG. 4B. By comparison, as shown in FIG. 4C, the transitions between the steps represented by the graphical elements 430 in the palette 420 can be defined within a conditional editor 460. The conditional editor 460 included as part of the composition tool 400 can permit the specification of contextual data for a selected step represented by a selected one of the graphical elements 430 in the palette 420, a condition, a value and a next step to be executed in the event that the contextual data evaluates to the value according to the condition.

Finally, referring to FIG. 4D, different SLOs can be specified for a step represented by a selected one of the graphical elements 430 in the palette within an SLO portion 490A of the composition tool 400. The SLO portion 490A can provide a listing of SLOs specified for the specified step. Responsive to the selection of one of the SLOs in the SLO portion 490A, an SLO dialog box 49B0 can be rendered in which the selected one of the SLOs can be edited as shown in FIG. 4D.

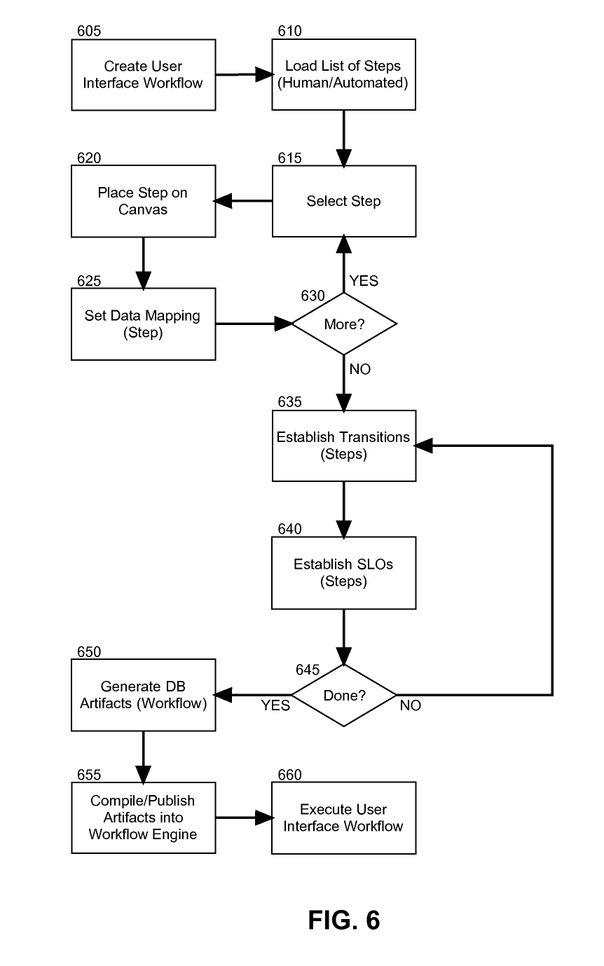

Utilizing the unified interface provided by the composition tool 400, an end user can rapidly define a user interface workflow and deploy computer readable instructions representative of the user interface workflow to a workflow engine without requiring the intervention of software development expertise. In even yet further illustration, FIG. 6 is a flow chart illustrating a process for user interface workflow composition. Beginning in block 605, auser interface workflow can be created in the composition tool user interface and a list of pre-defined steps, including both human steps and automated steps, can be loaded and rendered in a palette of the composition tool in block 610. In block 615, one of the pre-defined steps can be selected and placed onto the canvas of the composition tool in block 620.

In block 625, the contextual data of the placed step can be configured through the composition tool by specifying contextual data used by the placed step and to be provided to the step by another step, and/or contextual data produced by the placed step for consumption by other steps. In decision block 630, if additional steps are to be placed onto the palette, the process can repeat through block 615. Otherwise, the process can continue in block 635 with the establishment of transitions for each step placed in the palette. Finally, in block 640 SLOs can be established for selected ones of the steps placed in the palette.

In decision block 645, when all transitions and SLOs have been established as desired for the steps in the palette, in block 650 artifacts can be written to a database representative of the user interface workflo of the steps in the canvas, the defined transitions, the user interfaces for the human steps already defined for the human steps and the mappings of contextual data in the steps. Thereafter, in block 655, the artifacts of the database for the user interface workflow can be compiled into computer readabile instructions and packaged for publication can be passed to a workflow engine for loading and execution in block 660. Consequently, end-to-end, a user interface workflow—a variable sequence of steps both human and automated and corresponding user interfaces for the human steps workflow for CRM—can be defined and deployed without requiring intervention by an end user or end users possessing software development expertise.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-readable medium providing program code for use by or in connection with a computer or any instruction execution system.

For the purposes of this description, a computer readable medium can be any apparatus that can contain, store, communicate, transport the program for use by or in connection with the instruction execution system, apparatus, or device. The medium can be an electronic, magnetic, electromagnetic, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A user interface workflow composition method comprising:
loading into a composition module executing in memory by a processor of a computer from a data store coupled to the computer, a set of references to both human steps of a workflow, each of the human steps of the workflow referencing a corresponding user interface, and also automated steps of a workflow, each of the human steps and automated steps of the workflow individually comprising contextual data;
visually placing individual graphical elements each representative of a selected one of the human steps and automated steps into a canvas rendered by the composition module;
defining transitions between different ones of the human steps and automated steps represented by corresponding ones of the graphical elements in the canvas by creating visual connections between the different ones of the graphical elements in the canvas, the human steps and automated steps represented by the graphical elements in the canvas, and the transitions defined therebetween setting forth a user interface workflow; and,
generating computer readable instructions for the user interface workflow.

2. The method of claim 1, further comprising providing the computer readable instructions to a workflow engine to generate programmatic objects implementing the user interface workflow and to execute the programmatic objects for use by end users over a computer communications network.

3. The method of claim 1, further comprising:
inserting a different user interface workflow onto the canvas; and,
defining a transition to the different user interface workflow from one of the human steps and automated steps represented by one of the graphical elements in the canvas.

4. The method of claim 1, further comprising defining a service level objective for one of the human steps and automated steps represented by a selected one of the individual graphical elements.

5. The method of claim 1, wherein generating computer readable instructions for the user interface workflow comprises:
storing a plurality of artifacts in a database table representative of the user interface workflow; and,
generating the computer readable instructions for the user interface workflow from the artifacts in the database table.

6. The method of claim 1, wherein visually placing individual graphical elements each representative of a selected one of the human steps and automated steps into a canvas rendered by the composition module, further comprises:
defining an arrangement of different user interfaces corresponding to different ones of the human steps to be displayed together concurrently in a single display for a single human step represented by a rendered individual graphical element during execution of the single human step.

7. A workflow composition data processing system configured for user interface workflow composition, the system comprising:
a computer with processor and memory configured for communicative coupling to a workflow engine over a computer communications network:
a data store of pre-defined steps, comprising both human steps and automated steps, and screens corresponding to the pre-defined human steps;
a composition module executing in the memory by the processor of the computer, the module comprising computer program instructions enabled to load a set of references to both human steps of a workflow, each of the human steps of the workflow referencing a corresponding user interface, and also automated steps of a workflow, each of the human steps and automated steps of the workflow individually comprising contextual data, to visually place individual graphical elements each representative of a selected one of the human steps and automated steps into a canvas, to define transitions between different ones of the human steps and automated steps represented by corresponding ones of the graphical elements in the canvas by creating visual connections between the different ones of the graphical elements in the canvas, the human steps and automated steps represented by the graphical elements in the canvas, and the transitions defined therebetween setting forth a user interface workflow, and to generate computer readable instructions for the user interface workflow.

8. A computer program product comprising a computer readable medium embodying computer usable program code for user interface workflow composition, the computer program product comprising:
computer usable program code for loading a set of references to both human steps of a workflow, each of the human steps of the workflow referencing a corresponding user interface, and also automated steps of a workflow, each of the human steps and automated steps of the workflow individually comprising contextual data;
computer usable program code for visually placing individual graphical elements each representative of a selected one of the human steps and automated steps into a canvas rendered by the composition module;
computer usable program code for defining transitions between different ones of the human steps and automated steps represented by corresponding ones of the graphical elements in the canvas by creating visual connections between the different ones of the graphical elements in the canvas, the human steps and automated steps represented by the graphical elements in the canvas, and the transitions defined therebetween setting forth a user interface workflow; and,
computer usable program code for generating computer readable instructions for the user interface workflow.

9. The computer program product of claim 8, further comprising computer usable program code for providing the computer readable instructions to a workflow engine to generate programmatic objects implementing the user interface workflow and to execute the programmatic objects for use by end users over a computer communications network.

10. The computer program product of claim 8, further comprising:
computer usable program code for inserting a different user interface workflow onto the canvas; and,
computer usable program code for defining a transition to the different user interface workflow from one of the human steps and automated steps represented by one of the graphical elements in the canvas.

11. The computer program product of claim 8, further comprising computer usable program code for defining a service level objective for one of the human steps and automated steps represented by a selected one of the individual graphical elements.

12. The computer program product of claim 8, wherein the computer usable program code for generating computer readable instructions for the user interface workflow comprises:
computer usable program code for storing a plurality of artifacts in a database table representative of the user interface workflow; and,
computer usable program code for generating the computer readable instructions for the user interface workflow from the artifacts in the database table.

13. The computer program product of claim 8, wherein the computer usable program code for visually placing individual graphical elements each representative of a selected one of the human steps and automated steps into a canvas rendered by the composition module, further comprises:
computer usable program code for defining an arrangement of different user interfaces corresponding to different ones of the human steps to be displayed together concurrently in a single display for a single human step represented by a rendered individual graphical element during execution of the single human step.
